(19) United States
(12) Patent Application Publication
(10) Pub. No.: US 2009/0157515 A1
(43) Pub. Date: Jun. 18, 2009

(54) SYSTEM AND METHOD FOR MONITORING SALES, PURCHASES AND DISTRIBUTION OF PRODUCTS

(76) Inventors: Michael Lafauci, Brooklyn, NY (US); George Mangione, Massapequa Park, NY (US)

Correspondence Address: GOTTLIEB RACKMAN & REISMAN PC, 270 MADISON AVENUE, 8TH FLOOR, NEW YORK, NY, 10016-0601, US

(21) Appl. No.: 12/343,715

(22) Filed: Dec. 24, 2008

Related U.S. Application Data
(63) Continuation-in-part of application No. 11/671,617, filed on Feb. 6, 2007, now abandoned.
(60) Provisional application No. 60/771,137, filed on Feb. 7, 2006.
(60) Provisional application No. 60/824,292, filed on Sep. 1, 2006.

(51) Int. Cl. G06Q 30/00; G06Q 50/00; G06K 9/20; G06Q 10/00

(52) U.S. Cl. 705/15; 705/16; 340/5.83

(57) ABSTRACT

A tracking system for monitoring, controlling, and restricting the sale of alcoholic beverages based upon parameters independent of users, and further restricting sales based upon scans of a patron's ID, with data entered into a database, and continuously tallies of the number of alcoholic beverages the patron bought at the venue within a specific period of time. Restrictions stemming from regulatory or administrative bases are entered into the system, and the system then frequently canvasses selected sources and determines if any of the restrictions have been triggered. If triggered, sales across all sales venues are appropriately restricted. In addition, the system issues one. or more warning to the user/server when the patron approaches the maximum limit or restrictions are triggered. The system can also monitor various zones of a venue to determine if the patrons within any of the zones are drinking excessively. If they are, alcohol dispensing is stopped at the zone, or, alternatively, throughout the venue.

### RELATED APPLICATIONS

This application is a continuation in part of application Ser. No. 11/671,617 which claims priority to U.S. provisional application Ser. No. 60/771,137, which was filed on Feb. 7, 2006 both incorporated herein by reference.

### FIELD OF INVENTION

This invention relates generally to a system and method for monitoring and controlling sales, purchases and/or distribution of products. More particularly, this invention involves a system and method for protecting the public by controlling the purchase of beverages, foods, and other products, particularly alcoholic beverages, when additional consumption may reduce cognitive capacity and self-control to an individual, to people in general, as prescribed by law, or for yet other reasons. Even more specifically, the invention relates to a system and method for tracking, recording and/or restricting the purchase and distribution of alcoholic beverages and other alcoholic products.

### BACKGROUND OF THE INVENTION

A number of systems for controlling sales of products, such as alcoholic beverages or cigarettes, are known in the art. In one system, a patron's information is taken from an identification card, such as a driver's license, and is entered into the system. The patron's identifying information, which may include the driver's license number, name and age, is then printed on a wristband that is given to and worn by the patron. When ordering an alcoholic beverage, the information on the wristband is read at the point of service for the purpose of making a determination of whether the sale of alcohol is appropriate and authorized.

Another system utilizes a card with information stored on the card (usually by means of a magnetic strip) that specifies a predetermined amount of alcoholic beverage(s) allowed for purchase. Variations of this system are also known to calculate and take into account the number of alcoholic drinks purchased in a given period of time. Further, a password may be required to use such cards in connection with the purchase of alcoholic beverages. On cruise ships and in other venues, systems exist which use cards to determine age eligibility when purchasing alcoholic beverages. Other systems and methods employ video cameras, document readers or biometric readers in connection with making a determination in connection with the purchase of alcoholic beverages.

One major drawback of the aforementioned systems is that they are specifically designed to screen out and prevent minors from obtaining alcoholic beverages by screening a patron's age and identifying fake forms of identification, rather than to prevent potentially harmful, public intoxication of individuals who are legally permitted to consume alcoholic products (at least from an age perspective). Another major drawback from which these systems suffer is that they utilize proprietary patron identification methods (i.e., wristbands, magnetic cards etc.), and not universally-recognized and accepted, government-issued forms of identification. Such types of proprietary identification, including the bracelet and swipe card, may easily be exchanged between patrons. Further, such forms of identification may be falsified or altered by, for example, replicating a bar code on a bracelet or reprogramming a swipe card that incorporates a magnetic strip or other conventional form of memory. Still another drawback is that these systems do not recognize restrictions that are not consumer-specific, such as restrictions related to time or venue. For example, it may be desirable to prohibit sales of alcohol or other products at public venues such as football games after a certain point in the game or during a portion of the game, and prior art systems do not permit the automatic termination of such sales.

This invention overcomes these drawbacks by providing for an integrated system encompassing vendor functionality, patron functionality, automated functionality, and data from reliable sources.

### Definitions

To further assist in the understanding of the present invention, some of the terms used in this application are defined below.

“ID” means and includes any printed or electronic document, card or other article that uniquely identifies an individual and which is either impossible or very difficult to alter or reproduce. Examples include military-issued IDs, Federal- or state-issued IDs (i.e., passports, driver's licenses, etc.), credit cards, college-issued IDs, or any other ID issued and/or monitored by a reliable entity or source.

“Biometric scan” means and includes the act or result of measuring any physical human characteristic, including but not limited to fingerprints, retinas or irises of an eye(s), hand features, facial patterns, voice, and other characteristics that may be evaluated or measured; “biometric ID” means any of the physical human characteristics or measurements themselves. Biometric identification uses a set of intrinsic, typically immutable, physical characteristics attributable to only a single person, typically for the purpose of identifying that person with a high degree of certainty. The measurements of the physical characteristics are obtained when a person registers or scans in characteristics which are translated into a digital representation by appropriate software algorithms. When a person is later evaluated for the purpose of identification, another biometric scan is performed, the results of which are transferred into a digital representation, and this digital representation is compared to the baseline digital representation that was previously stored. Biometric identification is typically based on a probability match.

“Venue” means and includes all public and private locations of entertainment and enjoyment, sporting events, including locations for recreation where food and beverages are supplied, including, but not limited to, stadiums, parks, theme parks, arenas, hotels, lounge areas such as at airline terminals, cruise ships, bars, nightclubs, gentleman's clubs, dance clubs, casinos, private clubs, music halls, restaurants, theaters, reception halls, private rooms within a premises, entire or multiple floors within a premises, poolside at hotels/motels, ski slopes or any other location where food, drink or alcohol is served or where any other product with sales or consumption restrictions may be sold or distributed.

“Patron” means and includes any person in attendance at a venue or at an event taking place at a venue, whether the patron is paying for or obtaining alcoholic products or other restricted products free of charge. References herein to a fan at a game, patron, guest, hotel guest, or any other individual patron shall be used interchangeably with the term “patron.”

“Server,” when referring to a person, means and includes a cashier, waiter or waitress, bar attendant or barmaid, or any other individual selling, serving or otherwise dispensing food and/or beverages.

“User,” when referring to a person, means and includes all people who directly interact with the system via a form of data entry. Although users generally are employees who may be providing the system with data for triggering or transactional data, a user may also be a patron, such as when the patron inputs data through a touch screen-based transaction.

“Authorized user,” when referring to a person, means and includes the subset of all users who are granted permissions to modify pre-existing data or to provide certain types of data, such as notes, to the system. Authorized users include “operators,” who are those providing the system with algorithms for triggering and for direct triggers. Different authorized users may have different types or levels of permission.

Additional terms will be further defined herein, as needed.

### SUMMARY OF THE INVENTION

In its broadest aspects, the present invention provides a system and method that reliably monitors, controls, tracks, tallies, records and/or otherwise restricts the purchase, sale and distribution of products, including alcoholic and non-alcoholic beverages and non-beverage items. Data regarding patrons and their selections are tracked and captured through patron or vendor interaction with one or more of a variety of terminal devices and then the data are stored. Selected metrics are identified reflecting restrictions of sales of selected products. The captured patron and vendor-related data are analyzed to determine if thresholds are reached such that sales may need to be precluded. In this case, the invention identifies affected terminal devices and returns messages, instructions, or both to affected terminal devices, potentially including instructions to preclude sales.

It should be understood that while the following discussion is focused primarily on alcoholic beverages, the present invention is also applicable to other products as well, such as non-alcoholic beverages, tobacco products, or other products that might be precluded from non-universal or full-time distribution. The invention is also applicable to the tracking and monitoring of sales of other non-consumable products such as memorabilia, apparel, and sports-related items through use of its tracking and storage functions.

The system includes the feature of utilizing information keyed to the individual patrons and individual vendors (if any) so as to track the purchasing history of individual patrons, the sales history of vendors, and sales in portions of the venue, which enables an operator to tailor marketing and selling efforts to each individual patron.

In a general sense, the invention comprises terminal devices at which ordering and sales occur. The terminal device may be configured for allowing patron ordering, sales to patrons, delivery of product to patrons, or some combination. The device includes a means for reading information from a patron ID. Said means may be in a variety of forms, including but not limited to a card reader, a text or visual scanner, a biometric reader, or a person (server) with a keypad.

The present invention preferably includes significant flexibility in how ID is checked and validated. Checking may be accomplished at the point of sale or at the point of delivery or both. For example, to accommodate a phone-in order from a cell phone, a roaming vendor delivering product may be in possession of a hand-held device and may check ID (including performing a biometric scan at the time of delivery), or may have the freedom to override the check based upon visually observing the patron.

Also in a preferred embodiment, the terminals at which a transaction is originated and at which sales occur are in communication with a data processing element through a communication pathway. The pathway may be a wireless communication channel (e.g. WiFi). The data processing element captures real time information relative to parameters that affect the seller's regulatory and administrative permission to sell products. Using the ID-based information and the patron's selection of products for purchase as well as parameters regarding the patron, the system determines if there are existing restrictions, and transmits messages, instructions, or both, including present prohibitions, to any or all potentially affected end terminals and servers. Once the end terminals and servers are made aware of any present prohibition, the end terminals and servers may be delivered a warning for display, or announcement or the terminal devices may be precluded from completing the sale, or both.

For example, the data captured for processing by the data processing element may include time of day or, when alcohol sales are banned after a certain point in a game, the running time of the game. Once a designated restriction is in effect, the invention will automatically inform the terminals and servers to prohibit the offering of sale of affected products, such as alcohol, to any and all affected individuals, even when the individual is otherwise permitted to purchase (such as when the patron is of legal age and is notably sober). The system also may cause sales to be precluded based upon intervention of selected authorized users, such as in the scenario where a dangerous condition exists in the venue and where, in the authorized user's view, further sales would exacerbate the dangerous condition. This circumstance may result in preclusion of sales to an individual patron or to a group of patrons, such as those seated in a particular section of a venue.

The preclusion or restriction may take many forms, including but not limited to the form of stopping the dispensing of a liquid, stopping the financial transaction from being completed (in other words, an automatic shut off feature), or both. The preclusion may also take a venue-wide form by precluding sales from all in-venue sales locations. The preclusion may also take the form of limitations based on selected attributes, such as limiting the quantity of units or volume sold over a period of time or based upon a person's age. For example, the system may track an individual's purchase based on the alcohol content in fluid ounces and may limit the total quantity of alcohol or quantity over time (such as no more than 10 fluid ounces per hour or no more than two cups of a particular beverage in total, such as beer). The system may also correlate the data so that the patron's age is a determinative factor with respect to what type and volume of alcohol will be dispensed initially. The latter is beneficial if the patron is just over the minimum drinking age. The preclusion may also take the form of a prohibition to selected positions of the venue, such as when “alcohol free zones” are established. The closure of the offering of the sale of alcohol may be in several additional forms such as but not limited to the alcohol selection option disappearing from the menu afforded to a user, via a touch screen, a warning message (in writing, sound, or both) indicating that alcohol cannot be purchased any longer, limiting sales of only selected beverages, or any conceivable message to indicate the prohibition of sales of all or some products. When some or all preclusions are triggered, notification may be sent to security officers at the venue in the form of alerts to computers or alerts to devices carried by the officers, to the management of the venue, and/or to the operators of the food or beverage concession.

The system comprises a data processing element via which the system determines if triggers are met. The system additionally comprises a communication pathway for transmission of information to and from the data processing element. The communication pathway may be used for capturing data from public sources, such as from internet connections with data captured through any type of internal or external data feeds, such as RSS feeds. The communication pathway also may be used for data capture and delivery to terminal devices in a venue. The communication pathway may also be used for communicating with additional systems employed at additional venues or for communicating with terminals at additional venues.

The present invention also comprises a database for storing information. A portion of the stored information relates to a tally of the number of alcoholic beverage and other product purchases made by all the patrons within a venue. The system also has the capacity to tally the number of alcoholic purchases over a specified period of time for each individual patron and to cross-reference or compare the tally data with preset alcohol purchasing limits defined at or by controllers of a particular venue in order to determine if the patron has exceeded his or her limit with respect to purchase of alcoholic beverages and/or with respect to the pre-set time limit.

The stored patron and vendor information may be retained from event to event and from multiple venues. Information from multiple venues may also be aggregated so as to form profiles of patron, event, venue, and vendor activity. The patron profiles could include, among other items, the patron's home address, personal characteristics, such as age, gender, height, weight, food and beverage preferences, food and beverage allergies, and memorabilia preferences, apparel and/or hat sizes, or any other information deemed valid by the vendor to be useful to collect. The vendor profiles could include, among other items, the vendor's business address, telephone, facsimile and email information, the name of the contact person or persons, the type of products sold or services rendered by the vendor, and the identity of the venues serviced by the vendor.

The system also has the ability to limit purchases by a particular patron. The tally of purchases made by a particular patron enables the system to determine whether a patron has reached any maximum allowable limit, either within a certain time period or in relation to that person's personal characteristics (height, weight, age). The tally also affords an authorized user of the present invention flexibility to choose an action or pre-assign an action. For example, a server could be prohibited from making a sale, could have the choice of restricting further sale/distribution of alcoholic products to that patron, or could merely warn that patron that alcohol sale/distribution may be terminated in the future. This limit may be based on parameters including but not limited to the number of purchases, the volume of alcohol purchased, the age of the patron, the frequency of purchase, or the geographic location of the patron in the venue.

In addition to tracking the number of units of alcoholic beverages sold to different patrons, the tally may also be used, for example, to track data relative to a particular server or vendor, such as the number of drinks sold or dispensed, the number of cups dispensed, the type of alcohol sold, the fluid ounces of each type sold, and whether thresholds are reached. Also, the system can track the amount of alcohol included in all sales by patrons automatically, that is, without involvement of a server or vendor, and can insert limitations based on volume of alcohol or some other component of the sold product, in addition to limiting sales based on quantity of product. Also, the system can insert different limitations based on user or category of user. Using these data, the system can additionally serve as a fraud detection device and detect if a server is manipulating the number of drinks sold. For instance, a server at a stadium may be given a dozen cups for sale, each of which should contain ten ounces of beer or some other beverage, for a total of 120 ounces. The cups are typically generic plastic cups, not cups particular to each venue. Accordingly, if the server has a cache of his or her own cups, the server can pour eight ounces of beer in each cup rather than ten, thus gaining 24 extra ounces for use in extra cups. The server can then sell three additional eight-ounce cups of beer and look to keep the entire proceeds from these three cups. Prior art systems did not have the capability of monitoring this type of fraud.

Accordingly, if the server is delivering the alcoholic beverages without pre-orders, the server is preferably required to enter into the system the number of containers (i.e., cups, mugs) required, the corresponding number of drinks and the total volume of these drinks, at the time the venue provides the server with the cups and the alcohol, such as beer. The server is thus monitored directly by the venue and via the system. Then, the server will pick up the containers with the drinks for delivery to the respective patrons located in the stands of a stadium or another location within a venue. The system ensures in this manner that the server cannot dispense less than the mandated liquid volume per container. Prior to delivery of the alcoholic beverage to the patron, the server will also require that the patron present an ID to be read and/or submit to a biometric scan. In this manner, the patron's information will be entered into the system so that the tallies and comparisons to pre-set limits can be performed.

The system can employ different means of dispensing both alcoholic and non-alcoholic beverages as well as many other products. These means may include stationary housings fully staffed with several servers, portable point of sale systems with a limited number of servers, or an automated dispensing device and little or no personnel, automated kiosks with no personnel (where orders would be inputted but dispensing would not occur at the time of order), and roaming vendors carrying portable devices for controlling and tallying dispensed products and checking ID. The ID may be read using a known commercial ID scanner and a biometric scan may be effectuated through a known commercial biometric scanner. The person may also order by phone or by a device with a wireless interface, which communicates with the data processing element via its communication pathway. The patron can also use a touch screen interface for ordering, but not dispensing, which screen could be mounted on a countertop or at the patron's individual seat, for instance at a sporting event. When using a touch screen the patron ID could be checked at the time of ordering, the time of delivery, or both. The touch screen interface would be equipped with a commercial scanner to accept the ID and the biometric scan. All of these means are used for remotely tracking and controlling dispensing of both alcoholic and non-alcoholic beverages as well as many other products. The venue employees or servers are the users of the system, and patrons themselves may also be users when purchases are made from a kiosk, a portable device (i.e., can be carried by a person, not fixed to a single physical location), a cell phone or similar multi-purpose portable device, or from a device fixed at the patron's seat. Furthermore, a database of patrons and their purchase histories may be prepared from data received through transactions and the database may additionally accept updates from local, state and/or federal government agencies regarding past violations involving alcohol (i.e., DWI, DUI, and Disorderly Conduct).

The database of the system can be updated by authorized users or operators of the system, including venue owners, concession owners, employees, employers and servers, who can manually enter negative (or positive) information or notes with regard to individual patrons. Such notes may provide that a patron exhibited negative behavior(s) including “unruly behavior,” “disorderly conduct,” “ejection from the venue,” or the like. The system may retain information on each venue's unruly patrons. The system's database of unruly patrons can be examined by the server, authorized user, or operator of the system at any time to check if a particular patron has previously exhibited negative behavior. Some or all data may be optionally erased from the database by an authorized user at the end of an event or after a specified period of time. Preferably, for “unruly” patrons, a note section may be provided, permanently maintained or kept intact for a longer period of time, which contains all notes entered by one or more servers, users, and operators. When the notes section of the database is accessed, the database may automatically activate a list of standardized pop-up notes for a server, for example, to check off the items that apply to a patron, and store that information.

The system can also be used to determine if a particular segment or section of a venue is becoming too unruly or if alcoholic dispensation in a particular section is approaching a tolerance limit. If a section is deemed too unruly or if a limit is reached, alcohol distribution and sales to that section can be curtailed or ceased altogether. The restriction may include reducing the rate of alcohol sold per time period, the total amount of drinks, total amount of alcohol etc.

Further, the system may be linked to other systems, such as systems which dispense product without an associated direct financial transaction, such as liquor service at a luxury box of a sports stadium, so that sales of alcoholic beverages automatically terminate at pre-programmed times, whether such sales occur at kiosks or in connection with servers who implement orders from patrons. For example, the system may be programmed to forbid the sale of alcohol before noon on a Sunday or after a certain period of time has elapsed (i.e., after the sixth inning of a baseball game). The inventive system can also be used by other venues where alcohol is not sold past a certain time, such as bars which have a “last call.”

The system employs RSS (Rich Site Summary) feeds to automatically activate and deactivate the self ordering application. RSS is a format for delivering regularly changing web content. Many news-related sites, weblogs and other online publishers syndicate their content as an RSS feed to whomever wants it. RSS allows users to easily stay informed by retrieving the latest content from specific websites of interest. The system may also employ other types of data feeds to connect to an internal data source within the venue or to an external data source.

Data feeds, such as RSS feeds, are also employed for input to triggers which are used to deactivate specific items from the ordering screen at or near specifically mandated times. Those times are mandated either by venue management, regulatory authorities, or both.

The system retrieves content via a feed reader. Upon determining the nature of the desired content, it is simply a matter of finding the websites that syndicate content and adding their RSS feed to the list of feeds the Feed Reader checks.

The invention accordingly comprises the several steps and the relation of one or more such steps with respect to each of the others, the device embodying the features of construction, combination of elements and arrangement of parts which are adapted to affect such steps, and the article which possess these characteristics, properties and relation of elements, all as exemplified in the detailed disclosure hereinafter set forth, and the scope of the invention will be indicated in the claims.

It is an object of the present invention to provide a system and method for monitoring and controlling the purchase and sale of products and products.

### BRIEF DESCRIPTION OF THE DRAWINGS

The features and advantages of the tracking system will become further understood with reference to the following description, appended claims and accompanying drawings, in which:

FIG. 1 is a flow chart of a preferred embodiment of the present invention;

FIG. 2 is a block diagram of a system for implementing the invention of FIG. 1;

FIG. 3 is a flow chart for another aspect of the invention;

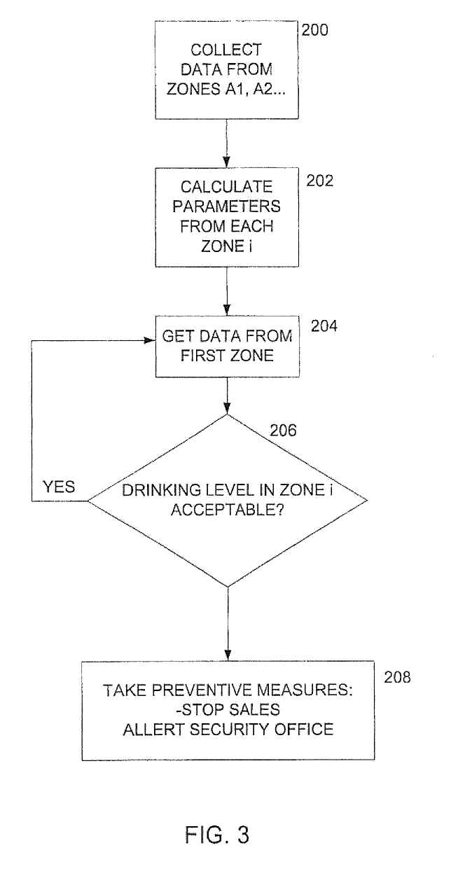

FIG. 4 is a flow chart for another aspect of the invention;

FIG. 5 is a flow chart for the time constraint rules of the invention;

FIG. 6 is a schematic view of the data feed interaction relative to a kiosk.

FIG. 7 is a flow chart of the decision process for preclusion.

FIG. 8 is a schematic view of the tallies performed by the invention.

### DETAILED DESCRIPTION OF THE INVENTION

The present invention pertains to a system that can monitor, control, track, tally, record, and restrict the purchase, sale and distribution of alcoholic beverages, non-alcoholic beverages and many other products within specific confines (such as a venue segment) and/or time frames at a specific venue. An ongoing tally or count of sold or distributed alcoholic and non-alcoholic beverages and other products, such as foods or memorabilia, preferably occurs at a point of purchase or alternatively at a point of distribution or both, but it should be understood that the information relating to the tally may be kept off site as well, at a location that is on site, at a point different from the point of purchase, or some combination. The invention cooperates with a variety of patron interfaces, both human and non-human, and patrons may purchase and receive product at a variety of vending locations discussed herein, ranging from standard full service counters with one or more servers, kiosks which may have a more limited number of products and fewer servers than a counter, roaming vendors with hand-held devices, and credit/debit/cash point-of-sale devices. As can be appreciated, several of the ordering devices are arranged for patrons to self-order products, without the aid of a vendor. All such devices can be a part of the system, giving them the capability to communicate with a centralized processor or group of processors. It should also be further understood that a system (comprising, for example, multiple kiosks, remote processors and counters with point-of-sale devices) at a particular venue may also be linked to one or more other systems that are located elsewhere, thereby forming a larger and more comprehensive system that is capable of performing its intended functions over a larger area and over multiple venues.

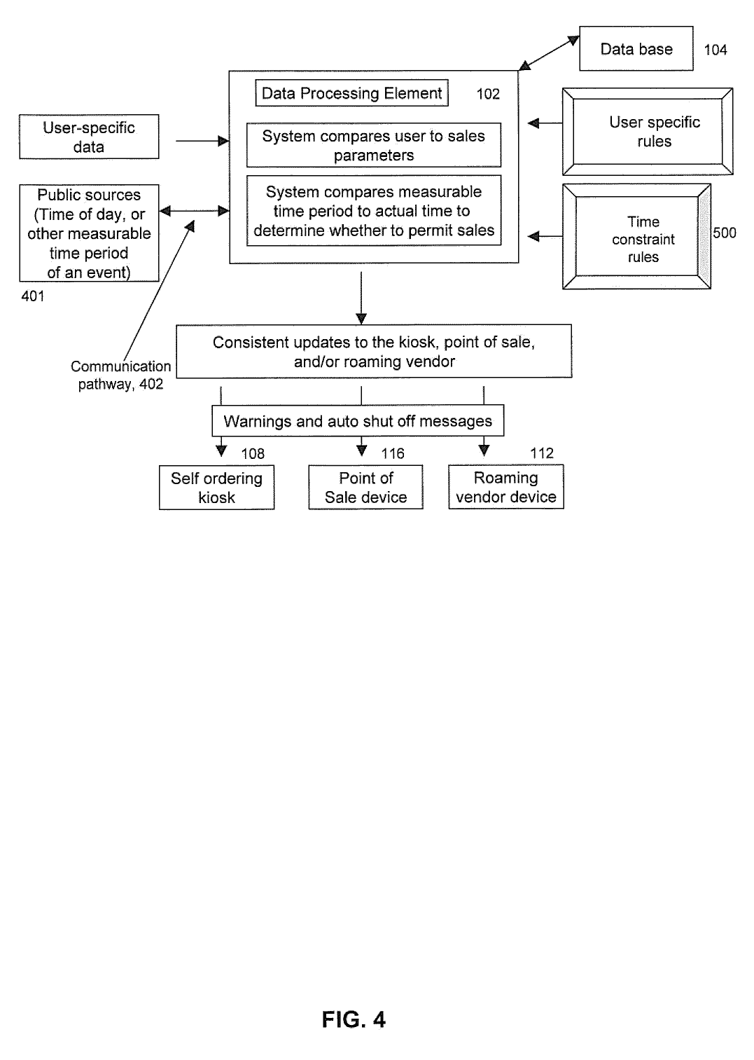

As illustrated in FIG. 4, the inventive system includes several interconnected elements. The system includes a data processing element 102 with an associated database 104. The data processing element 102 accepts data from a variety of sources, including public sources 401, such as internet accessible web sites, including those with RSS feeds, and sources within operating venues using communication pathway 402. Operators direct the processor to establish triggers for restricting or precluding product sales based on a variety of parameters related to the products themselves, the patrons, the venues, and information from the plurality of sources.

Within a venue, devices for data collection (patron data collection devices) communicate with data processing element 102. These points of data collection may also serve as points of purchase and points of distribution and may include traditional point of sale terminals, such as wireless point of sale devices held by roaming vendors 112, kiosks 108, point of sale devices 116, touch screens, such as those permanently mounted on walls or other surfaces or temporarily mounted on movable platforms, patron-held portable devices such as cell phones and PDAs, fixed devices such as seat-based touch screens, dispensing devices, and others. These points of data collection may also communicate with or be integrated with point of sale terminals. The patron data collecting devices may be fixed at a location, such as a touch screen of a kiosk, or may be more mobile. Patron data collecting devices communicate with the data processing element regularly for data transfer purposes. Some patron data collecting devices may have their own data processor elements. Said connection means may be wired or wireless, using, for example, internet protocol -over POTS or WiFi. Patron information, including information related to patron ID and payment, is collected by patron data collecting devices and communicated to the processor.

For example for each potential delivery of products, the data processing element 102 determines if a predetermined range of threshold for a predetermined parameter (e.g., alcohol consumption) is achieved and returns messaging or instructions to the affected patron data collecting device for further handling. If the transaction is to result in a sale, data regarding the financial transaction is also captured by the patron data collecting device and communicated to the processing element for further handling. The system can also print receipts.

General Operation of System

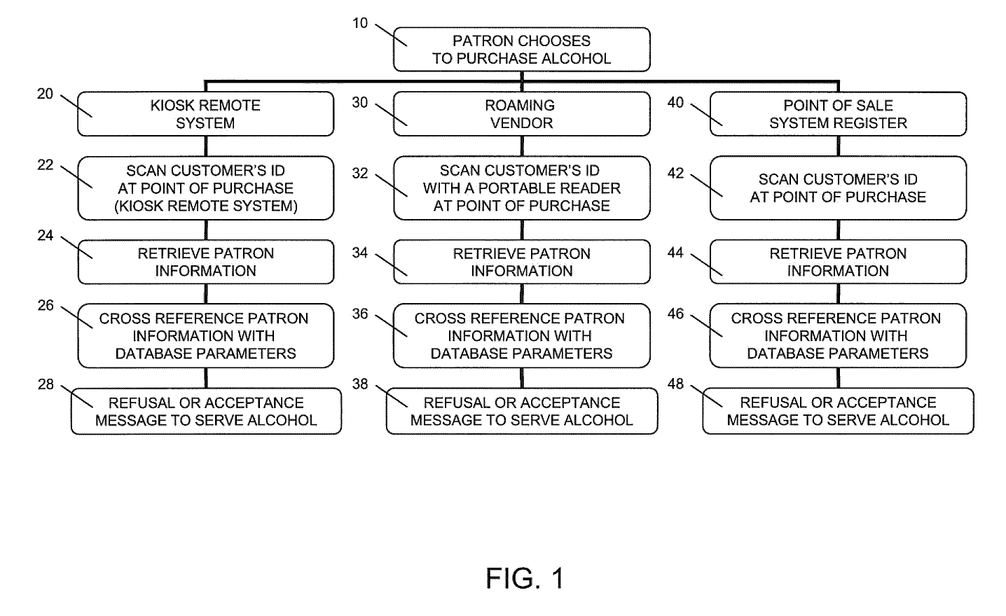

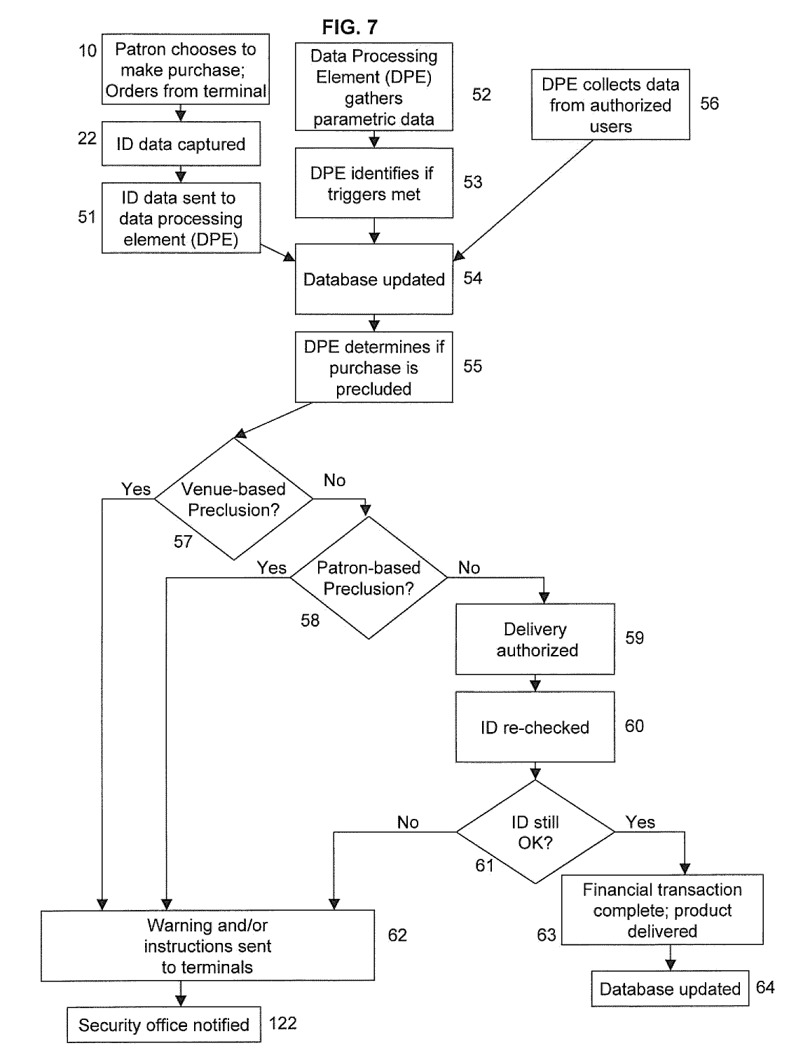

The operation of the subject system is now described in conjunction with FIGS. 1, 2, and 7. As shown in the flow chart of FIG. 7, the method begins along three parallel tracks. The first track involves a patron's commencement of an order. At step 10, a patron places an order. As stated, the order may be made from a kiosk, from a roaming vendor, or from a point of sale terminal, or from numerous other terminals as described below.

FIG. 1 shows the process steps for three different types of ordering terminals. In all three cases, the patron chooses to purchase a product, such as an alcoholic drink, as in step 10 of FIG. 1 and FIG. 7. The patron places the order, such as at a kiosk 108, as depicted in FIG. 1 step 20, or with a roaming vendor at step 30. Although a variety of devices may be employed, for simplicity, the example used here is the application of a kiosk, however, the system can similarly employ other terminal devices.

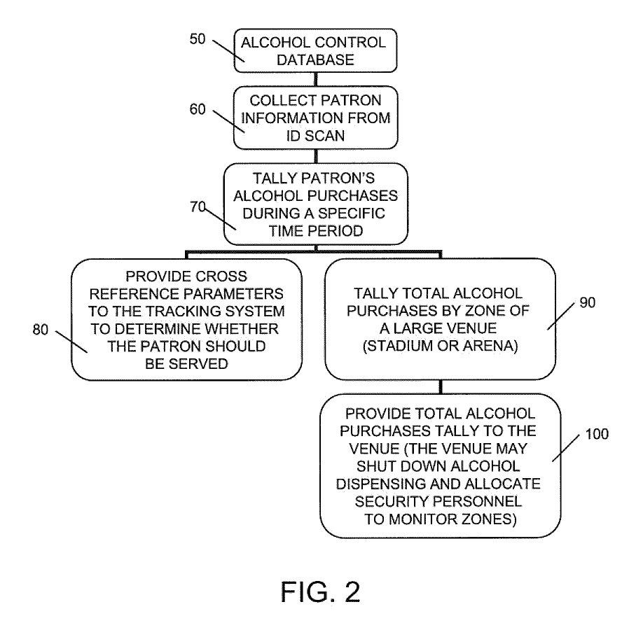

Referring to FIG. 2, the order can be placed at one of several different locations including dispensing means from (a) a kiosk 108, (b) a roaming vendor device 112, or (c) counter or other Point of Sale location or device such as, e.g. a point of sale device, 116 (steps 20, 30, or 40). Each dispensing device may contain its own processor, such as kiosk processor 106 at kiosk 108. Among other purposes, the processors at these devices may provide capability for processing payment, and payment can be ultimately be accepted using cash, credit or debit card, or a combination of any of these known payment vehicles.

The next step is to scan a patron's ID. Although such a scan may occur at a variety of terminal devices the scan at a kiosk is described herein for illustrative purposes. Referring to FIG. 7, the patron is obligated to provide ID for the order to progress. The presented ID is then scanned (such as in step 22 at a kiosk). Data from the ID is captured in step 22, for example, using a card reader or by touch screen entry. Upon capture, ID data are sent to the data processing element as shown in Step 51. The scanning process triggers a communication with the data processing element 102, where information regarding the patron is retrieved from the database (shown as step 24). Subsequently, data processing cross-references the patron information with parametric data in the database, element in step 26 and a message is returned to the kiosk refusing or accepting the purchase, in step 28. FIG. 1 displays corresponding steps for ordering from a roaming vendor (30, 32, 34, etc.) and ordering from a point of sale terminal (40, 42, 44, etc.).

As discussed above, the patron ID may be based on a biometric scan. The biometric scan may be in any of a number of forms. Upon an initial visit or purchase, the patron would have at least one bodily attribute initially scanned (the “baseline scan”). A digital form of the scan would remain in the patron-attribute portion of the database. Upon an attempted purchase, the same bodily attribute is scanned again, the results of the scan would be digitized, and the results are compared to the digitized results of the baseline scan. Upon match, the purchase may be authorized. Bodily attributes which may be scanned include but are not limited to finger prints, iris, retina, voice etc.

If the patron uses a touch screen to place the order and the touch screen is equipped with an ID scanner and/or biometric scanner, then the process is the same as described above. However, if the touch screen does not have an ID or biometric scanner, then the patron must first pay for the order at the touch screen. After inputting and paying for the order, the patron must proceed to a station at which the ID and biometrics are confirmed. In the pre-sets, the venue can elect whether or not the patron receives a refund if the patron's information is not confirmed, The touch screen will contain the appropriate messages to the patron regarding the pre-sets.

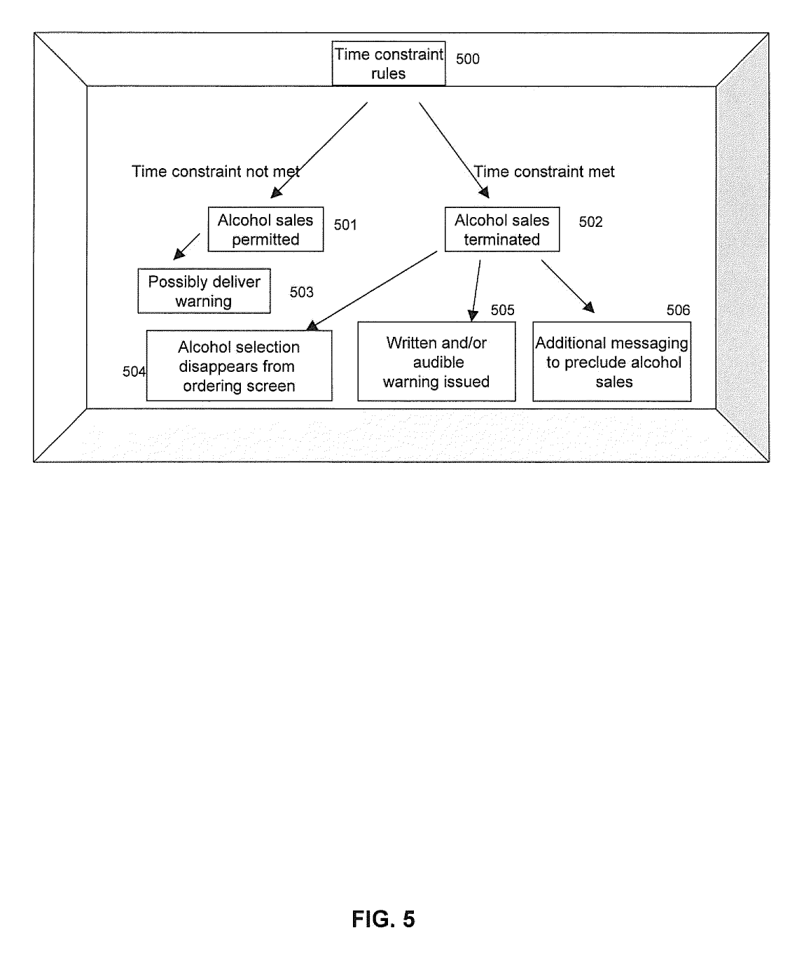

The reader is directed to FIGS. 1, 2, 4, and 7. Using the scanned data, a patron's information, which may include basic information and history of past alcohol purchase, together with the applicable rule(s) 500 (see FIG. 4) or parameters for limiting the sale of alcoholic beverages (steps 24, 34, 44), is retrieved from database 104 by one of the processors 106, 110, 114 directing data processing element 102. The information is then cross-referenced or compared by data processing element 102 to parameters or rules for alcohol distribution (steps 26, 36, 46) including rules based on time of day or other general prohibitions on sale, including the approach shown in the flow chart of FIG. 5. In response, a refusal or acceptance message to serve alcohol is provided (steps 28, 38, 48) to the respective dispensing device (108,112,116) for further respective action by the processor (if any). Where the dispensing device 120 is embedded within the ordering station, for example at kiosk 108, the dispensing device 120 has an associated dispensing processor 118. If the sale is to be precluded, data processing element 102 communicates to dispensing processor 118 a turn off instruction. For example, if the patron has exceeded a predetermined threshold, the patron and the server may receive a printed note or an electronic message informing them of the same. A copy of that note is saved and/or printed for the server as well. This decision may be made strictly based on the number of drinks or the number of ounces of alcohol consumed by the patron. More sophisticated determinations may be made using the weight of the patron, his/her gender, his/her past history, etc. and all this information may be placed on the note. More complex warnings may also be generated. For example, a patron may be issued a warning that he or she is approaching the limit set by the venue, or that this is the last drink that he can get for the next X hours, etc.

Returning to FIG. 7, a second track involves parametric data, such as the time of day or status of a game. The data processing element 102 gathers the requisite parametric data in step 5.2 using communication pathway 402. Typically, the data sources offer RSS feeds and data processing element 102 is equipped to read RSS feeds. Element 102 analyzes the captured data to determine if any preclusion triggers have been achieved. If one or more triggers are met, messaging and instructions may be returned to terminal devices, as detailed below.

The third track involves data offered by authorized users. Referring to FIG. 7 and step 56, data is captured from authorized users, such as data indicating overrides to preclusions, restrictions to selected sections of a venue, or introduction of additional parameters to determine preclusions.

As data are collected from all three tracks, the data are provided to database 104 and database 104 is updated, as depicted in step 54. The update involves both patron-specific information, such as the quantity of beverage purchased, the time of purchase, and the seat location of the patron (if available), but also captures information regarding the vendor, including the method of payment and quantity of liquid dispersed. Following database update, a decision process begins in step 55 for determining a preclusion is in order. The present invention determines if there are either venue-based preclusions (step 57) or patron-based preclusions (step 58). These steps correspond to step 26 in FIG. 1. The present invention determines whether these preclusions are achieved based upon triggers provided in advance by an operator or based on additional triggers identified by authorized users, such as those based upon patron activities in a venue or a section of a venue.

If preclusions are required, the data processing element 102 determines which delivery terminals may be affected and in step 62 returns warnings or instructions to the affected terminals. In some cases, terminals may be precluded from further sales. If preclusions are not required, the delivery is authorized, as set forth in step 59. The system also permits the venue to adjust the preclusions or deactivate them.

Once delivery is authorized, the ID may be rechecked (step 60) to assure the recipient is still entitled to receive the product (for example, assuring that the patron is of sufficient age). If the ID is not adequate, warnings and/or instructions are returned to the affected terminal in step 62 and the sale is not completed. Additionally, messages may be provided to security office 122. A menu-driven interface may eliminate the precluded product from selection options made available to the patron or vendor. If the ID is adequate, in step 63, the financial transaction is completed, whereby the patron pays with cash or credit/debit card or through draw down from a preset account that the patron has established with the venue, and the product is delivered. Steps 62 and 63 correspond to step 28 in FIG. 1.

Step 63 encompasses completion of the financial portion of the transaction. In addition, if the terminal includes the ability to dispense a product, the product will be dispensed to the patron. In addition, data regarding the transaction is captured and the database is updated. In addition, data captured at this step is used to update the database, as shown in step 64.

Time Constraint Rule Process

FIG. 5 displays a flow chart of the time constraint rules. The system determines if a time constraint is met and accordingly if alcohol sales are to be precluded. If a time constraint is not met, alcohol sales are permitted (step 501). Alternatively, depending upon parameters determined by the operator or authorized user, a warning may be delivered, step 503.

If a time constraint is met, alcohol sales are terminated, (step 502), and additional actions are instituted. Menu-based delivery options, such as touch screens, will have their displays adjusted such that alcohol selections disappear from the ordering menu, as in step 504. Additional written or audible warnings may also be issued, as in step 505. Also, additional messaging regarding precluding alcohol sales may be provided, (step 506). Such messaging may take a variety of forms, including audible messages to radios held by security officers.

Data Processing Element

FIG. 2 shows a block diagram of a system 100 constructed in accordance with this invention. The system 100 includes a data processing element 102. As discussed above, data processing element 102 can be on site at the event or can be at a remote location. Moreover, the data processing element 102 may provide other functions as well that are not related to the product distribution discussed herein. The data processing element 102 is coupled to a database 104 that is used to store patrons IDs, purchase histories (including alcoholic and non-alcoholic products), the rules for alcohol distribution and other associated data, and rules for distribution of other products. The data processing element 102 also exchanges data with a kiosk processor 106, a roaming processor 110, and/or a point of sale (POS) processor 114.

In one embodiment, the system includes a separate dispensing device 120 associated with a dispensing data processor 118. The device 120 can dispense products to patrons after the patrons have been authorized to purchase a product and have paid and when no other restrictions have been imposed. The dispensing device 120 may require each patron to provide an ID before receiving a product to insure that the patron is the same person as the one who has been authorized previously.

The time constraint rules relative to alcohol sales are shown in the flow chart of FIG. 5. If a time constraint is not met, the system permits alcohol sales 501. In addition, under operator-established conditions, a warning may still be delivered to one or more affected terminal devices, as in step 503. However, if a time constraint is met, such as a curfew for sales of alcohol, as in step 502, one or more of several communications may be provided to affected terminal devices. For menu-driven ordering, the alcohol selection options may disappear from the menu, such as from a visual touch menu, as in 504. Written and/or audible warnings may be issued, as in step 505. Also, additional messaging to affected terminals or other devices, such as security officers, may be provided as in step 506.

Significant attributes of the system are described in detail below.

ID Checking

The system may have access to state motor vehicle records with driver's license information or any other governmental database with identifying information to check for underage patrons, to prevent minors from buying alcohol or to prevent purchases of alcohol from those convicted of DWI or DUI. In a further embodiment of the present invention aimed to prevent underage drinking (as well as attempts to purchase alcohol with a fake ID or someone else's ID), the system may employ a camera that, using face recognition, compares the patron's image with the driver's license. Alternatively, the system may employ other human recognition mechanisms, such as fingerprint readers, iris readers, or voice recognition elements.

Communication Pathways

The system may employ one or more networks to connect its devices in order to update and retrieve patrons' information, process credit card payments and/or to have access to DMV records or law enforcement agency records. The devices connected to the networks may be a combination of point of sale locations, kiosks, and/or portable remote devices such as mobile phones. The networks may be landline (phone, coaxial cable, DSL, fiber optic cable) or the networks may utilize wireless communications (satellite, WIFI, cell phone, cellular digital packet network, or any other suitable wireless connection).

In a sporting event the software application polls specific Internet or Intranet websites or other sources that provide the information in order to commence the activation and deactivation processes. For example, websites with current information on time of day or game status (such as the current inning of a baseball game) are polled and data regarding time of day or game status are extracted for use by the processor and database. An operator may establish pre-set intervals at which time the data is to be extracted.

Information regarding sales, especially sales of alcoholic beverages, may be shared with other entities, such as a security office 122, the concession vendors, operations centers, customer service, or any other entity whom the venue elects to receive the information.

The processors monitor and provide controls and data information to the respective vending locations. Of course, processors 106, 110, 114, 118 can be discrete elements implemented as a single device or can be integrated into the master processor 102, however, they are presented here as separate units for the sake of clarity.

Vendor Data

Master processor 102 is associated with a display 130 on which various supervisory personnel can monitor the operation of the system, the number of drinks sold, the number of patrons rejected, etc. In addition, sales may be restricted more generally, and the present invention may recognize meeting the conditions for a restriction and implement such restriction. For example, a regulatory ban may be imposed after a certain hour or for certain events. In another example, if the venue is a sporting event, alcohol consumption may administratively be banned after a certain point in the game or match. In these circumstances, as seen in FIG. 4, the data processing unit 102 is provided with the requisite data for determining when restrictions should be imposed and utilizes a communication pathway 402 which may, for example, include a wireless or satellite-based medium using embedded internet protocol to communicate with public sources 401 to capture current data regarding, for example, time of day or status of a game. Data processing unit 102 then compares the two sets of data to determine if a restriction should be applied or if it is to be applied in the near future. The processing unit then implements the time constraint rules as shown in FIG. 5 and notifies each of the sale positions (such as the kiosks, 108) of the particular conditions applicable for the sale. Once notified, the sales positions may, as appropriate, provide a warning to patrons (FIG. 5, 505) and may preclude further sales (506) until each sales position receives a revised notice permitting sales.

Reading the ID

In a preferred embodiment, a patron presents an ID, from which information is read. ID information is then transferred via the communication pathway 402 to the data processing element 102. The data processing element 102 analyzes the data to determine if any present preclusions are in order. If the ID is accepted, meaning no preclusion is triggered, the purchase is flagged as one which may be completed, with payment in cash or by credit/debit card. In addition, the present invention may permit an authorized user or server to override the lack of triggered preclusion and to restrict patrons' alcohol purchases upon monitoring the patron's current alcohol consumption or for other reasons. Moreover, the system may provide multiple levels of redundancy to permit purchase, for example by requiring a server to compare the ID with the credit/debit card. This approach can be used to verify the patron's age eligibility to buy alcoholic beverages and to avoid the exchange of IDs among patrons, regardless of whether the purchase is for credit or cash. In the context of a credit card or other identifier which may be freely exchanged between patrons, it is desirable to at least visually match basic information present on the ID with the credit card, such as the name on a patron's driver's license with the name on the credit card (or information stored on both) or to match signatures, to ensure that the credit card does not belong to a different patron. Moreover, the patron's fingerprint or other biometric scan may be used to verify that the patron submitting a particular form of ID is indeed that person.

Sales Preclusions

Specific menu items are also similarly managed. Alcohol sales, for example, may be prohibited after a certain point of the game, after a certain time of day or in a certain venue section. Upon the system comparing the parametric data to its programmed triggers, the system may preclude alcohol purchases. If parameters are met, all alcoholic menu items are simultaneously removed from all ordering screens at the venue, thus preventing purchases of alcoholic beverages after the prescribed time. Using baseball as an example, if the venue prohibits alcohol sales after the first pitch of the eighth inning, the data feed, such as RSS or live incoming feed, will cause a trigger to deactivate or preclude further alcohol sales at the predetermined game time prior to the first pitch of the eighth inning. Furthermore, if the municipality prohibits alcohol sales after a certain time of day, the data feed, such as RSS or live incoming feed, would similarly cause the trigger to be achieved. For example, if a game has been rain delayed or has had extremely long innings and the municipality prohibits alcohol sales after 11:00 p.m., the processor will first look for both the game and clock times. If it is only the fifth inning at 10:55 p.m., the clock time feed will engage the alcohol deactivation before the inning requirement is satisfied since it will be 11:00 p.m. before it is the top of the eighth inning.

Alternatively, the patrons of a certain venue section become inordinately rowdy. Upon seeing a command, the system reduces, restricts or precludes alcohol sale in that section. Depending upon the trigger, once a triggering event is achieved, the processor may direct all or some of the patron data collecting devices concurrently. The processor may be physically located at the venue itself or at a remote location. Operators at the venue also have the ability to change the pre-sets, deactivate one or more of them, or implement a complete override, as the venue is presented with different situations during each event. The data processing element 102 may automatically turn-on/shut-down functions simultaneously on all kiosks/POS/Roaming Vendors alcohol selection choice at a specific venue. For example, if it is 10:00 p.m. in New York City, and both the Yankees and Mets are playing at home, each network of kiosks/POS/Roaming Vendor selections will be affected by the specific game time at the specific venues. If it is top of the eighth inning in the Yankee game in the Bronx, and the bottom of the fifth inning in the Mets game in Queens, alcohol sales will be prohibited in the Bronx but permitted in Queens.

The data processing element 102 may obtain the parameters for restricting sales or for providing a warning through operator input. The operator programs the data processing element by ordinary means, such as through use of a browser and internet connection. The data processing element captures current data, for example, through use of the system's communication pathway, 402. In the preferred embodiment, the data processing element polls applicable web sites and extracts the requisite information via the polling function. Alternatively, the processing unit can use its uplink connectivity function to query outside sources and operate based on the obtained response. In the event that a trigger is achieved and selected products (such as alcoholic beverages) are precluded from further sale, touch screen and other patron data collecting devices with visual displays of available products will at that point forward no longer display the selection from the patron's available purchase options.

Kiosks

At each kiosk 108, the patron can purchase alcohol with a pre-cash money card, gift card, cash or with a Credit/Debit card. Each kiosk can provide both types of transactions, or alternatively different kiosks are provided for cash and for credit/debit transactions. The kiosks may employ touch screens, voice assist or recognition technology to guide the patron during the process.

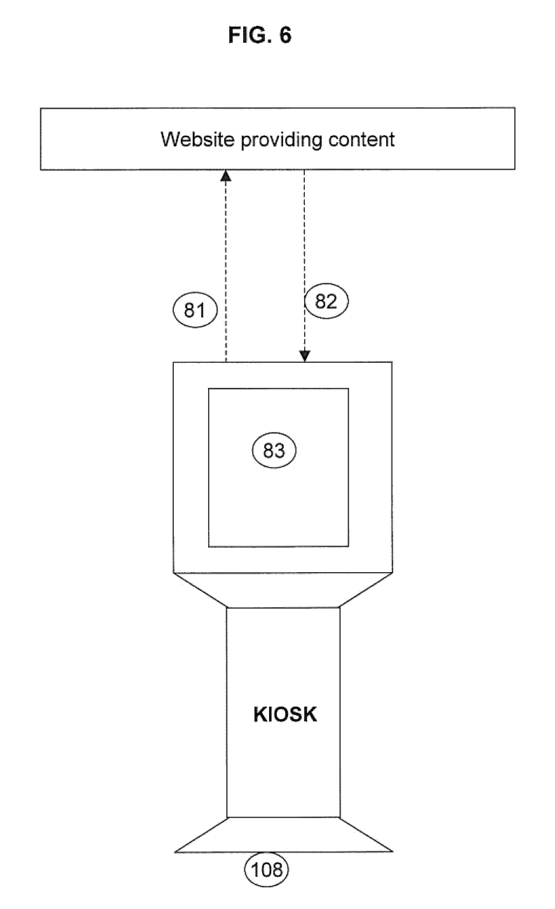

Unlike other terminal devices, the kiosk can capture source data offered by the data feed and can retain its own set of rules (See FIG. 6). This may be advantageous as kiosks may comprise unstaffed dispensing devices and the venue operator may want a failsafe mechanism to preclude sales when restrictions are implemented.

Self-ordering

As stated, the system permits patrons to self-order. The self ordering system automatically comes online and offline at a predetermined time prior to the beginning and end, respectively, of the event. For example, at a baseball game, a designated website(s) or a specific data feed (such as an intranet or internet feed) is polled to ascertain the scheduled first pitch. The system comes online at the predetermined time interval, say one hour, prior to the first pitch. Similarly, the system goes offline after obtaining data indicating a triggering event has occurred, such as commencement of the inning of the game that prompts the shutdown, for example, bottom of the eighth inning and one out.

The system can further be implemented without the need for a server at every location. A patron can go to a kiosk 108 and the kiosk 108 may include in one embodiment an automated ordering device that can process automatically all the information required for later dispensation of an alcoholic beverage, including a scan of the patron's ID, an appropriate verification thereof, and whether any sales restrictions are in order. Minimizing the server input required to serve an individual patron allows one server to serve more patrons, which is desirable at any venue, particularly a venue with a high patron throughput. Preferably, the system may request that a dispensing vendor ask the patron to provide his ID again when picking up the alcoholic drink to ensure that the authorized patron is the person actually picking it up at the kiosk and is of legal drinking age.

Self ordering may also be accomplished by personal phone, such as a mobile phone. The patrons may order by dialing a preset telephone number and being directed through voice prompts to respond to menu options. Patrons would be obligated to identify themselves and also identify their preferred method of delivery. Patrons could potentially respond by voice response or touch pad. Self ordering may also be web based, where the patron would access a website containing the venue's menus, and the required ID and biometrics scan would occur on pick-up. These self ordering methods may be used by the patron from any location prior to arriving at the venue.

Self ordering may similarly be achieved by a PDA or PDA-like device, via email or the text function. Again, patrons would be obligated to self identify and also identify their preferred method of delivery, all through offered menu options.

As discussed above, as part of the transaction, the data processing element 102 determines whether a patron is authorized to purchase an alcoholic beverage, based on attributes of the patron, such as the patron's age, previous and current history and/or other rules, such as a prior record of unruly behavior and whether alcohol sales are generally prohibited at that time. The information is then relayed back to local processors, such as 106, 110, or 1 14, and the result of the evaluation could include a warning indicating that the maximum amount to be served has been reached (in which case the patron is refused) or information that the patron is approaching the maximum amount to be served. In an alternate embodiment, the message includes a warning to the vendor or some other personnel to check the patron for sobriety (using, e.g., a breath analyzer), or a warning to complete a visual check for sobriety or drunkenness. The vendor can then choose to dispense the alcohol or refuse the alcohol purchase. A printed receipt may be generated in duplicate, for the patron and for the venue's records, to confirm the purchase or in the event of denial of purchase.

The system is flexible in the manner in which ordering and delivery of product are accomplished. The ordering process may be performed by a patron from the patron's own terminating device, such as a mobile phone or PDA; from a mobile device, such as from a device carried by a roaming vendor; or from a fixed device, such as a kiosk or point of sale terminal at a counter, with a variety of interfaces, including a touch screen, an audible interface, or by communicating with a vendor. The delivery may also be completed in a variety of ways, including automated pouring of a beverage, or a person-to-person encounter for purposes such as ID confirmation or financial completion.

Dispensing Devices

As mentioned above, at the point of pick up, preferably the person picking up the alcoholic beverages must pass a verification process using his or her ID and the patron may also be required to submit to a biometric scan. Alternatively, if automated ordering is used, then the person picking up an order provides his or her ID and biometric information to the dispensing server (person) 120. The dispensing device 120 checks through its processor 118 whether an alcoholic drink can be dispensed, and then, if allowed, the device dispenses the beverage.

The kiosks may be adapted to accommodate roaming vendors as well in a section of a venue (i.e. stadium stands or the like).

In another alternative, a patron may order by mobile phone or be alerted by mobile phone that the order is ready.

Roaming Vendors

Referring again to FIG. 2, another preferred embodiment of the present invention provides the purchase of alcohol from a roaming vendor through a remote vending device 112. The vendor can accept payment via cash, credit, or debit. This roaming, remote payment process is executed by the vendor who walks around the venue, and whose purpose comprises selling alcohol. A portable device 112 including reader (not shown) is carried or is disposed nearby the vendor. The vendor scans a patron ID and the transaction proceeds as described below in FIG. 7. The portable device includes a LCD or other similar display, or a paper printout in which information (including messages regarding a particular patron) are provided to the vendor. The receipt paper may additionally include messages, such as, for example, advertising for a local business. If the device 112 is portable, communication with its processor 110 can be accomplished via standard wireless communication means. The portable device may also disallow a sale if any sales prohibitions are in order at that time. In the case of a denial of service, the roaming vendor could see the alcohol sale option disappearing from her screen or a denial of service message could appear on the screen or be printed.

The tally for each transaction and the patron-specific ID and other information is stored in database 104, beginning at the first purchase, where the term “first purchase” in this context means the first purchase within the confines of a particular venue, on a given system or a particular event.

Preferably, the tally and the information is preserved in the database 104 until the end of the event or until the patron exits from the facility or for an extended period of time, as may be desired for later review and analysis. Such later review could include developing a database of patrons which can be used to track unruly behavior or patterns of alcohol purchasing, to better serve that patron. The gathered data could include not only the personal characteristics of the patron but the patron's seat information, and general information regarding the behavior of the patrons in a particular section. Once the set time passes, the database records the number of alcoholic beverages consumed during the event. Optionally this data can be transmitted to external data collection sites. The tracking system can also generate various reports using the recorded information. One report can be generated to each roaming vendor. The system has the ability to retain this information in case it is needed in a later dispute.

Point of Sale Purchase

A patron may also make a purchase at a location or housing including, for example a full service counter for selling many different products, among them alcoholic beverages, with one or more servers and at least one point of sale (POS) device 116 such as a register. The POS device 116, exchanges data with master processor 102 (and optionally the other locations) through POS processor 104. As can be appreciated, the process using a point of sale device is similar to the process involving a kiosk.

Menu-Driven Applications

Several applications include patron ordering without involvement of an authorized user. Examples of such applications include patron ordering from a fixed terminal at a seat location, patron ordering from a fixed kiosk, or patron ordering via mobile phone or PDA, or patron ordering from a mobile touch screen, a permanent touch screen, or a web based application. Some of these applications may include a screen whereby patrons touch their selection. In any of these situations, patron ordering is menu-driven; that is, the patron is afforded options for purchase and the patron selects from the options made available. In these circumstances, when reasonably possible, the patron's ID and biometrics are initially authenticated. In the situation where the patron orders by mobile phone, the patron must self-identify through, for example, noting seat location. Once the authentication process completes, a menu is provided to the patron. In selected situations, the menu is a visual menu on a touch screen. In other selected situations, the menu may be an audible menu, such as on a mobile phone. Based upon the patron and the parametric situation, the system returns a menu limited to products available for purchase by that patron. For example, if the system recognizes the patron as under age or the time of day is after the trigger time at which alcohol sales are precluded, the menu returned by the system will not include alcohol products. Similarly, the patron's ID and biometrics must be re-authenticated at the time of delivery and the system may preclude completion of the transaction at that time based upon the circumstances.

In an alternate embodiment, the server, or other personnel (e.g., security personnel employed by the venue) may check a patron for sobriety, for example by giving the patron a physical or mental test. The results of the tests are recorded, printed on the note and stored as well. If the order is accepted and no other restrictions are in order, the patron is served.

When a patron requests alcohol or alcohol is to be delivered to the patron, the system retrieves the patron information including historic data such as the type and amount of the previously purchased alcoholic beverage(s). The required information can be retrieved from the database by using the ID or biometric scan provided by the patron.

As discussed above, an important feature of the invention is that a patron has to present an ID for each order or affirm their age namely, at a point of purchase or pickup. The patron information may be obtained from a magnetic stripe, barcode, RFID, digital image, on an appropriate document or may be obtained by scanning in text from a document and converting text. The ID information may include the patron's name, drivers' license number, ID number, birth date, height, photograph and/or biometric data or a combination of the foregoing items. The patron may also be queried with respect to alcohol preferences or sensitivities, such as allergies. Once a transaction with a patron is completed, the corresponding information is updated in database 104 so that the information can be used in the future to maintain data on a patron's alcohol choices (to better serve the patron) or to track unruly patrons (so that the venue can be aware of the patron's nature and choose to limit the dispensation of alcohol and be ready if security is needed). The data processing element 102 tallies all subsequent alcohol purchases by a patron by calculating the number of the alcoholic beverages purchased by the patron, preferably within a predefined period of time, and stores the results in the same or different database that stores patron's identifying information. The tally is held in database 104 (and or other memory), beginning at the first purchase, where the term “first purchase” in this context means the first purchase within the confines of a particular venue, on a given system, at a particular event, or a particular date. Preferably, the tally is kept until the end of the event, until the patron exits from the facility or perhaps for an extended period of time, as may be desired for later review and analysis. The time period and threshold levels used to control alcohol purchases is typically defined by the host venue, by using a number of parameters, which may include opening and closing hours of operation of the venue, time from first dispensation of alcohol and last, or time of opening until alcohol purchases are terminated. More sophisticated rules for determining these thresholds may also be used, including the age of the patron, his/her prior history, criminal records, etc. It should be understood that the rules for setting these thresholds may be set by a person or entity other than the host venue, and that such time period may be a universal standard applied to multiple venues. To be effective, one large venue, such as an arena or stadium, may require its restaurants inside the stadium and other points of alcohol dispensation to use the tracking system so that the time period is uniformly defined for any particular patron. Venues in a city or any other geographically-defined locale may likewise find it beneficial to use the tracking system in the same or similar manner.

Restrictions to Portions of a Venue

The monitoring and tallying of purchases may be integrated with the architectural layout of the facility (the venue being: an arena, stadium, bar, restaurant, dance club, or gentlemen's club). The operator can set color graphics or define highlighted areas to show an authorized user the number of purchases from a given area, section, gates, or rows of the venue.

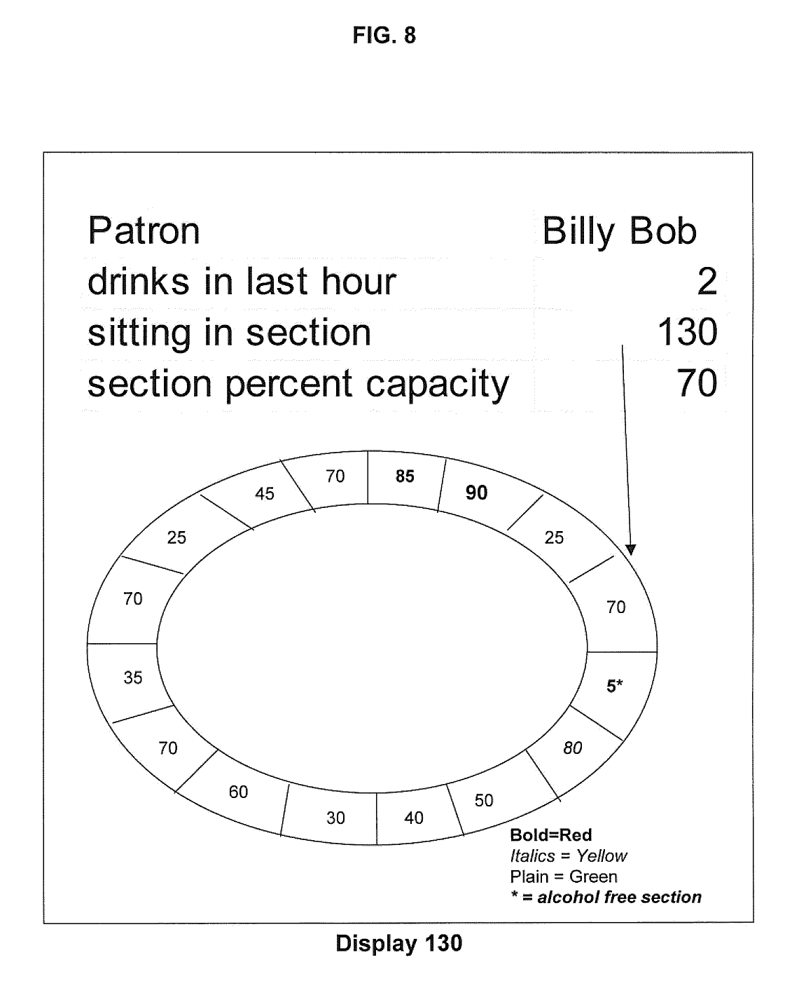

In an alternate embodiment, the data processing element 102 tallies the number of drinks (and/or the amount of alcohol) consumed by a patron on an individual basis, and also accumulates this information for a number of patrons, based on designated zones within the venue. A representation of display 130 depicting these results is shown in FIG. 8. For example, the individual patron's purchase data is collected and tallied to obtain a cumulative number within sections, gates, floors, or rows of the venue. This total amount per zone, or alternatively, the alcohol consumption per capita can be shown in display 130 in any suitable format, such as a table consisting of one column identifying the various zones of the venue and another column indicating the amount of alcohol consumption in each zone. Alternatively a map is generated on the display 130 of the venue with various zones color coded to show alcohol consumption. For example, the various zones may be green, yellow and red to indicate cold, warm and hot zones, respectively, with green indicating low alcohol consumption, yellow indicating moderate alcohol consumption and red indicating high alcohol consumption. The data processing element 102 also calculates the total alcohol consumption for the whole venue. The end user or viewer (concession management, security, and operations management of the venue) is then able to view, monitor and zone the purchases according to the gates, sections, and rows, versus total purchases of alcohol. The venue management can also take appropriate measures such as restrict, limit or shut down alcohol dispensing within a particular area or zone. Alternatively, or in addition, a message is sent to the security office to request the assignment of additional security personnel to particular zone area.

To summarize, the alcohol consumption in a public venue can be curtailed or controlled both on an individual level, and in the whole venue. On an individual level, in one embodiment, the alcohol consumption is completely cut-off when the individual reaches a predetermined threshold based on the number of drinks consumed, the volume of alcohol consumed, etc. In an alternate embodiment, two or more thresholds are set for individuals. Alcohol consumption may also be controlled or restricted in various zones based on a number of different parameters, and even on universal basis affecting all the zones in a particular venue. Moreover, the controlling of alcohol consumption can be implemented in a number of different ways, using a single step, or multiple steps. In one embodiment of the invention, when a threshold for the respective area (be that an individual, zone or universal), a control signal is generated by the software indicating that no more alcohol is to be sold. Moreover, the control signal may also be generated when a particular time-sensitive event occurs that need not be directly related to alcohol consumption. For example, the signal may be generated at baseball game when the eighth inning starts, at a football game at the beginning of the fourth quarter, at a soccer game after 75 minutes of play, and so on. The control signal can be generated automatically by the software or a switch can be actuated manually by a security or management personnel.

In another embodiment, two or more thresholds may be used. When the first threshold is reached, a warning may be generated to the individual (and, if applicable, the vendor) or others indicating that a critical period has been reached and the sale of alcohol is going to be cut off soon. Moreover, the warning may be issued to a vendor if he has sold a beverage to a customer after the signal to stop sales has been received. Finally, an electronic or electromechanical valve is provided which, in response to the control signal, is activated to actually open or close a pipe that is used for the delivery of alcoholic beverages. The control signal can be generated at a remote location. The venue also has the ability to override the presets and choose to dispense the beverage.

As mentioned above, the present system can also be used to monitor the number of drinks sold by vendors to insure that the customers are not short changed. In one embodiment, this function is performed by comparing the number of drinks sold with the number of cups used. In another embodiment, a flow meter is used to measure the amount of alcohol is sold by volume.

Although the invention is described in terms of particular embodiments, it is to be understood that the embodiments are merely illustrative of an application of the principles of the invention. Numerous modifications may be made and other arrangements may be devised without departing from the spirit and scope of the invention. For example, the tracking system is just as applicable to venue events where alcoholic beverages are distributed without requiring payment from the patrons rather than sold (i.e., an “open bar” reception where the system can be used to track and restrict alcohol consumption to meet the goals of the present invention).

It is also to be understood that the following claims are intended to cover all of the generic and specific features of the invention herein described, and all statements of the scope of the invention which, as a matter of language, might be said to fall therebetween.

1. A system for restricting sales of at least one product to at least one patron attending an event in at least one venue, said system comprising:
at least one data collector for capturing situational data during said event, said situational data comprising data representing sales activity for said at least one product to said at least one patron;
a data storage medium for storing a database comprising said situational data, said database further comprising predetermined parametric data representing at least one condition under which said sales are to be restricted;
a data processor for updating said database and for comparing said situational data with said parametric data during said event to determine whether said at least one condition has been met and for generating in such case at least one indication that sales of said at least one product are to be restricted;
at least one display for presenting said at least one indication; and
at least one communication pathway for providing communication among said data processor, said data storage medium, said at least one data collector, and said at least one display.

2. The system of claim 1 wherein said situational data further comprises patron data for each said at least one patron, said patron data comprising data identifying each said at least one patron and data representing a cumulative tally of prior and impending sales activity for said at least one product to each said at least one patron during said event.

3. The system of claim 2 wherein said at least one condition comprises a limit representing the total quantity of said at least one product that may be sold to each said at least one patron during said event, and wherein for each said at least one patron said data processor performs a comparison between said tally and said limit to determine whether impending and future sales activity for said at least one product to said at least one patron are to be restricted.

4. The system of claim 3 wherein said data processor further generates a first indication when said tally exceeds a predetermined value that is less than said limit.

5. The system of claims 3 wherein said data processor further generates a second indication when said tally exceeds said limit.

6. The system of claim 1 wherein each said at least one venue comprises a plurality of sectors, wherein said at least one data collector comprises a plurality of data collectors and at least one of said plurality of data collectors is situated within each one of said plurality of sectors, and wherein said situational data further comprises sector data representing the cumulative total of prior and impending sales activity for said at least one product in at least one of said plurality of sectors during said event.

7. The system of claim 6 wherein said at least one condition comprises a limit representing the total quantity of said at least one product that may be sold during said event to all patrons situated within each said at least one sector, and wherein said data processor performs a comparison between said sector data and said limit to determine whether impending and future sales activity for said at least one product within said at least one sector are to be restricted.

8. The system of claim 1 wherein said at least one condition comprises a limit representing a predetermined elapsed time following the start of said event after which sales activity for said at least one product within said at least one venue are to be restricted, wherein said situational data further comprises data received on a continuous basis representing the current elapsed time following the start of said event, and wherein said data processor performs a comparison between said current elapsed time and said limit to determine whether impending and future sales activity for said at least one product to each said at least one patron are to be restricted.

9. The system of claim 2 wherein each said at least one venue comprises a plurality of sectors, and wherein said at least one condition comprises one or more conditions selected from the group consisting of a first limit representing the total quantity of said at least one product that may be sold to each said at least one patron during said event, a second limit representing the total quantity of said at least one product that may be sold during said event to all patrons situated within each said at least one sector, and a third limit representing a predetermined elapsed time following the start of said event after which sales activity for said at least one product within said at least one venue are to be restricted.

10. The system of claim 9 wherein said at least one data collector comprises a plurality of data collectors, each one of said plurality of data collectors comprising an ID receiver for receiving said identifying data.

11. The system of claim 10 wherein said ID receiver is adapted to receive said identifying data from one or more data sources selected from the group consisting of a document scanner and a biometric scanner.

12. The system of claim 11 wherein said document scanner is adapted to produce said identifying data by scanning and digitizing at least a portion of a document selected from the group consisting of a credit card, a debit card, a driver's license and a passport.

13. The system of claim 11 wherein said biometric scanner is adapted to produce said identifying data by scanning and digitizing a bodily attribute selected from the group consisting of one or more fingerprints, a voice print, a facial image, and one or more ocular images.

14. The system of claim 11 wherein each one of said plurality of data collectors is associated with at least one order station for receiving an order from said at least one patron for said at least one product, each said at least one order station comprising a POS device and being selected from the group consisting of a fixed order station and a mobile order station.

15. The system of claim 14 wherein said fixed order station and is selected from the group consisting of a stationary service counter operated by a human vendor, a stationary automated kiosk, a touch screen interface, and a telephone.

16. The system of claim 14 wherein said mobile order station is selected from the group consisting of a portable kiosk, a wireless interface, and a hand-held device carried by a roaming human vendor.

17. The system of claim 14 further comprising at least one input device configured to receive said parametric data only from authorized users, said at least one communication pathway further providing communication between said at least one input device and said data processor.

18. The system of claim 1 wherein said at least one product comprises at least one alcoholic beverage.
